(19) United States
(12) Patent Application Publication
(10) Pub. No.: US 2009/0241063 A1
(43) Pub. Date: Sep. 24, 2009

(54) INFORMATION PROCESSING APPARATUS, INFORMATION PROCESSING METHOD, AND COMPUTER READABLE MEDIUM FOR DESIGNING A GUI

(76) Inventors: Junichi TAKAMI, Yokohama-shi (JP); Tetsuya Sakayori, Tokyo (JP); Hiroko Mano, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/406,635

(22) Filed: Mar. 18, 2009

(30) Foreign Application Priority Data
Mar. 18, 2008 (JP) 2008-069154

(51) Int. Cl. G06F 3/048

(52) U.S. Cl. 715/838

(57) ABSTRACT

An image processing apparatus that includes a processor, an image acquiring unit that acquires drawing images which are images corresponding to a plurality of prepared scenes on a plurality of pages of drawings, an image storage that stores therein the respective drawing images, a thumbnail image producer that produces thumbnail images by reducing a size of each of the drawing images, a list producer that produces a thumbnail list in which the produced thumbnail images are arranged, a thumbnail outputting unit that outputs the thumbnail list, an entered-information extractor that extracts entered information entered into the thumbnail list, an information recognizing unit that recognizes, from the added information, both area positions defined in the thumbnail list and the thumbnail images linked from the area positions and an information manager that controls storage of both the recognized area positions and the thumbnail images linked from the area positions.

### CROSS-REFERENCE TO RELATED APPLICATIONS

This application is based upon and claims priority under 35 U.S.C. §119 to Japanese Patent Application No. 2008-069154 filed in Japan on Mar. 18, 2008, the entire contents of which are hereby incorporated by reference.

### BACKGROUND OF THE INVENTION

1. Field of the Invention

This invention relates to an information processing apparatus, information processing method and a computer readable medium for designing a GUI.

2. Description of the Related Art

In recent years, the GUI (Graphical User Interface) has become increasingly prevalent. In a GUI, graphics are heavily used to present information to a user such that the user can perform fundamental operations with only a pointing device.

The elements which constitute a GUI are created electronically. Thus, in order to create these elements, programming skill as well software tools, etc. are required. For this reason, quick development of the GUI is difficult.

On the other hand, in the initial stage of design and development of a GUI, an experimenter usually wants to only evaluate fundamental operations of a GUI. However, since the appearance of even initial GUI contents created electronically is good, the experimenter's mind is apt to focus on details of the graphic design instead of the fundamental issues which are important for the experimenter to review. Such details of the graphic design include the size of a font, the use of color of each part article, etc., which draw the attention of the experimenter.

Thus, in order reduce distraction paper prototyping is used in the initial stage in design and development of a GUI (for example, non-patenting reference 1 reference).

Specifically, before designing the GUI, paper prototyping is used to simulate the workflow of the GUI by producing hand-drawn GUI drawings for each scene created by user action. This type of usability test takes into account opinions of users and evaluates whether the specifications of the GUI are suitable before creation. Thus, mistakes of the design and correction of faults can be easily performed in the initial hand-drawn GUI stage before extensive programming begins which could be more difficult to correct. For this reason, the paper prototyping has the advantage of reduced development cost.

[Non-patenting reference 1] The “paper prototyping” Carolyn Snyder (work), Masaaki Kurosu(translation) Ohm-Sha Ltd.

However, the paper prototyping mentioned above has the problem that the substitution of the GUI drawings in the experiment is complicated. That is, although the GUI drawings for every scene can be easily created by hand-drawn work, it requires a great burden for an experimenter.

### SUMMARY OF THE INVENTION

It is an object of the present invention to at least partially solve the problems in the conventional technology.

According to an aspect of the present invention, there is provided an information processing apparatus comprising an image acquiring block that acquires drawing images which are images on a plurality of pages of drawings prepared for every scene, an image storage that stores therein the respective drawing images, a thumbnail image producer that produces thumbnail images by reducing in sizes the respective drawing images, a list producer that produces a thumbnail list in which the respective thumbnail images are arranged respectively, a thumbnail outputting block that outputs the thumbnail list, an entered-information extractor that extracts entered information entered to the thumbnail list, an information recognizing block that recognizes, from the added information, both area positions defined in the thumbnail list and the thumbnail images linked from the area positions; and an information manager that manages both the recognized area positions and the thumbnail images linked from the area positions.

According to another aspect of the present invention, there is provided an information processing method comprising, an image acquiring that acquires drawing images which are images on a plurality of pages of drawings prepared for every scene, an image storing that stores therein the respective drawing images, a thumbnail image producing that produces thumbnail images by reducing in sizes the respective drawing images, a list producing that produces a thumbnail list in which the respective thumbnail images are arranged respectively, a thumbnail outputting that outputs the thumbnail list, an entered-information extracting that extracts entered information entered to the thumbnail list, an information recognizing that recognizes, from the added information, both area positions defined in the thumbnail list and the thumbnail images linked from the area positions; and an information managing that manages both the recognized area positions and the thumbnail images linked from the area positions.

According to still another aspect of the present invention, there is provided a computer program product including computer program codes stored on a computer-readable recording medium which when executed on a computer cause the computer to execute the image processing method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a system diagram exemplifying the configuration of an information processing system including an information processing apparatus according to an embodiment of the present invention;

FIG. 2 is a block diagram showing an exemplary hardware configuration of an apparatus according to an embodiment of the present invention;

FIG. 3 is a view exemplifying a thumbnail list sheet;

FIG. 4 is a block diagram showing configurations for the processes of the thumbnail list sheet production, link setting, and drawing display;

FIG. 5 shows a plurality of pages of GUI drawings prepared for a number of scenes;

FIG. 6 is a flowchart showing a method of producing a thumbnail list sheet according to an embodiment of the present invention;

FIG. 7 is a view exemplifying a thumbnail list sheet to which additional information is added;

FIG. 8 is a view exemplifying another thumbnail list sheet to which additional information is added;

FIG. 9 is a flowchart showing a method of link setting according to an embodiment of the present invention;

FIG. 10 is a diagram exemplifying the link setting process;

FIG. 11 is a flowchart showing the flow of drawing the display; and

FIG. 12 is an illustration showing changes of the GUI drawings.

### DETAILED DESCRIPTION OF THE PREFERRED EMBODIMENTS

Exemplary embodiments of the present invention will be explained below in detail with reference to accompanying drawings.

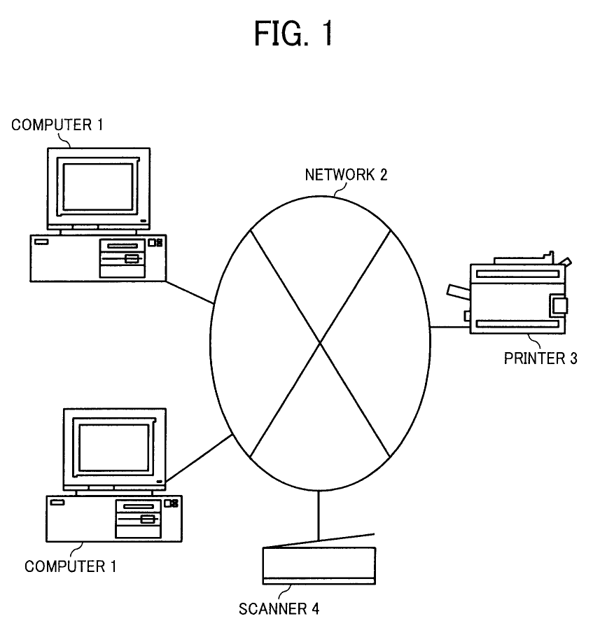

FIG. 1 is a schematic illustrating a system configuration according to a first embodiment of the present invention. In an information process system according to the present embodiment, printer 3 and scanner 4 are connected to a computer 1 via a network 2 such as a local area network (LAN), the internet, or the like.

Digital document data created by computer 1 is transmitted to the printer 3 via the network 2. The digital document data is printed out by the printer 3. Moreover, the digital document data read via the scanner is transmitted to the computer 1 via the network 2.

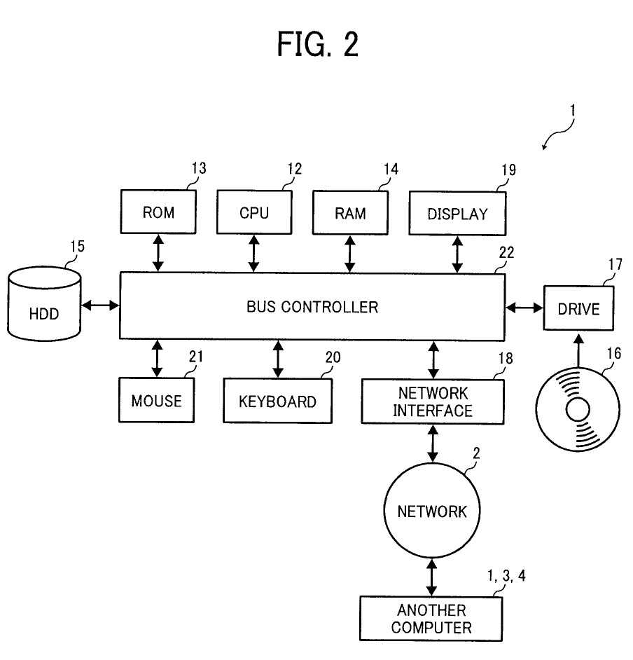

FIG. 2 is a block diagram illustrating an exemplary computer 1. The exemplary computer (hereinafter, “computer”) 1 includes a central processing unit (CPU) 12, a read only memory (ROM) 13 that stores, at least, a basic input output system (BIOS), a first storage such as a random access memory (RAM) 14 that temporarily stores information during processing, a second storage such as a hard disk drive (HDD) 15 that stores an application program, a processing result, and the like. Further, the computer 1 includes a drive 17 for a removable medium 16 serving as a storage medium for externally storing information or distributing information externally. Further the removable medium 16 can be used to obtain information (an application program, etc.) from an external source. In addition, the computer 1 includes a network interface 18 for connecting to the network 2 and communicating with external computers, a display 19 that displays a progress and a result of a processing, and a keyboard 20 and mouse 21 which are used by an operator to input instructions and information to the computer 1.

Moreover, the computer 1 includes a bus controller 22 which controls data communication among the above components.

Various storage media may be used as the removable medium 16. The storage media includes a magnetic storage medium, such as a flexible disk, a hard disk, or a magnetic tape; a magneto-optical storage medium, such as an magneto-optical disc (MO); an optical storage medium, such as a compact disk (CD), a compact-disk read-only memory (CD-ROM), a compact-disk recordable (CD-R), a compact-disk rewritable (CR-RW), a digital-versatile-disk read-only memory (DVD-ROM), a digital-versatile-disk recordable (DVD-R), a digital-versatile-disk random-access memory (DVD-RAM), a digital-versatile-disk rewritable (DVD-RW), and a digital-versatile-disk rewritable (DVD-RW), and a semiconductor memory.

In data transmission, data is transmitted to the network interface 18 and the network interface 18 outputs a signal to the network 2. The network interface 18 judges whether the data received by the network interface 18 is necessary. Further, the network interface 18 captures the data if the data is necessary, and discards the data if the data is unnecessary. Transmission and reception of all data received from the network 2 is performed through the network interface 18.

In general, when a viewer turns on the power to the computer 1, the CPU 2 starts a program called a loader included in the BIOS in the ROM 3, which loads an operating system (OS) for managing hardware and software of the computer 1 into the RAM 14 from the HDD 15. Once the OS is started, the OS supports start of an application program which reads and stores information according to operation by the user. Windows (trademark of Microsoft Corporation) or UNIX (trademark of X/Open, Inc.) are representative examples of such an OS. An application program operates on the OS. The application program is not limited to an application program operating on a predetermined OS and may be an application program that causes the OS to execute a part of processing, or may be an application program included as a part of a group of program files constituting predetermined application software, OS, or the like.

In general, when the application program is to be installed, the application program is first recorded on the removable medium 16 and from there is installed in the HDD 15. Therefore, the removable medium 16 can be a recording medium that stores the application program. The application program may also be first obtained from an external source via, for example, the network interface 18 and then installed in the HDD 15.

In the computer 1, when the application program begins operating on the OS, the CPU 12 executes various kinds of arithmetic processing to centrally control the respective units according to the application program.

Hereinafter, of various kinds of calculation processing executed by the CPU 12 in the computer 1, characteristic processing according to the present embodiment will now be described.

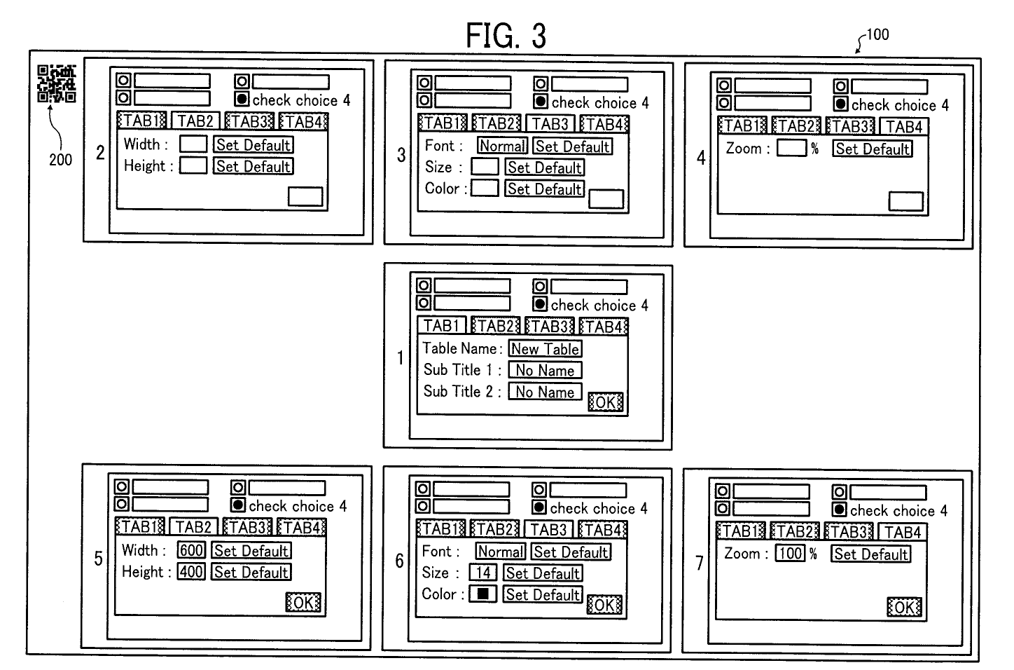

In general, in an embodiment of the invention, the described characteristic possessing relates to paper prototyping in designing and developing a GUI. In this processing, two or more pages of GUI drawings, which were prepared for a scene and scanned by a scanner 4, are reduced in their sizes and produced as thumbnail pictures. Then, a thumbnail list sheet 100 shown in FIG. 3 is printed out by the printer 3.

Thumbnail list sheet 100, shown in FIG. 3, contains an arrangement where the thumbnail pictures of plural pages are placed together on one sheet or several sheets. It is to this thumbnail list sheet 100 scanned through the scanner 4 that an added link of each GUI drawing portion is added. The link of the GUI drawings is set up based on both the area information on the GUI drawings and the added portion and the corresponding link information. Hence, a hyperlink can be set to the image contents produced by scanning the plural pages of hand-drawn GUI drawings. Therefore, the image contents which enable an interactive display are easily generated.

A storage such as the HDD 15 of the computer 1 stores, as application programs, a thumbnail list sheet creation program, a link setting program, and a drawing display program. Hence, when the thumbnail list sheet creation program, the link setting program, and the drawing display program, which are all operable on an operating system, are activated, the CPU 2 controls each necessary part of the apparatus based on these programs so as to execute a thumbnail list sheet creation process, a link setting process, and a drawing display process.

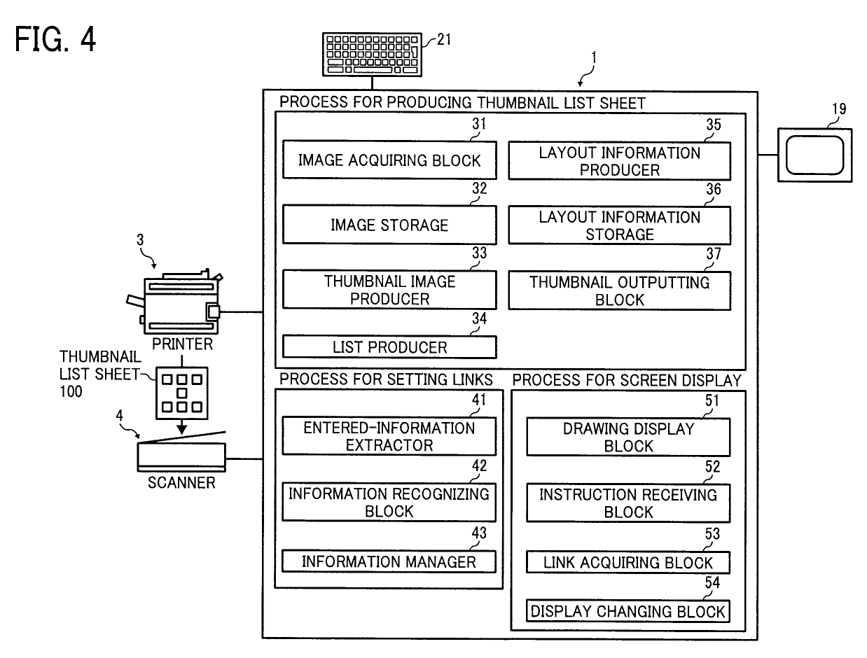

FIG. 4 is a block diagram illustrating the thumbnail list sheet creation process, the link setting process, and the drawing display process, which are performed by the computer 1, i.e., CPU 2.

[Thumbnail List Sheet Creation Process]

The thumbnail list sheet creation process will now be described. As shown in FIG. 4, the computer 1 executes the thumbnail list sheet creation program by making the CPU 12 operate on the operating system. This permits the computer to functionally have an image acquiring block 31, an image storage 32, a thumbnail image producer 33, a list producer 34, a layout information producer 35, a layout information storage 36, and a thumbnail output device 37.

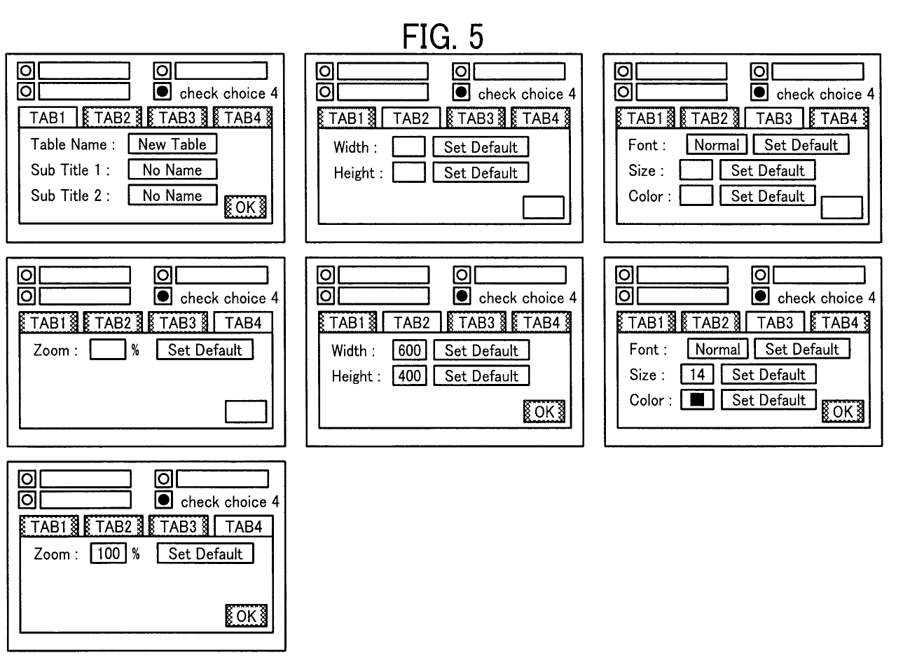

The image acquiring block 31 receives two or more pages of GUI drawings scanned by the scanner 4, and, thereby, acquires the pictures of the GUI drawings. FIG. 5 pictorially shows an example of the two or more pages of GUI drawings prepared for each scene. Each GUI screen is composed of characters or pictures originally printed or hand-drawn on a medium such as a piece of paper. Further, these drawings are prepared for each scene and are used for paper prototyping in the designing and developing of the GUI. Each GUI drawing is produced by hand-drawing a design for each scene on a sheet in accordance with the GUI specifications. (In this embodiment, there are N-sheet design pictures in total.)

The image storage 32, which is disposed within a memory device such as a HDD 15 or a RAM 14, is used to store the images of GUI drawings scanned by the image acquiring block 31.

The thumbnail image producer 33 produces thumbnail images by reducing the images of each of the plurality of pages of GUI drawings scanned.

The list producer 34 produces a thumbnail list, in which the thumbnail images of the several sheets are arranged. The thumbnail list is produced in N-variations, each variation including, as a central element, a thumbnail image produced from an image of one of the GUI drawings.

However, it is not required that the thumbnail images of all GUI drawings scanned by the image acquiring block 31 are listed in the thumbnail list. Instead it is also possible that only select thumbnail images of GUI drawings are listed.

The layout information producer 35 produces N-variations of the layout information indicating, for each GUI drawing, where each page is arranged and at which position in the thumbnail list produced by the list producer 34.

The layout information storage 36, which is disposed within a memory device such as a HDD 15 or a RAM 14, is used to store layout information produced by the layout information producer 35.

The thumbnail outputting block 37 outputs information indicative of the thumbnail list to the printer 3, so that the printer 3 is able to print the thumbnail list sheet 100 shown in FIG. 3.

In the thumbnail list sheet 100 shown in FIG. 3, the GUI drawing displayed first is arranged at a central part of the sheet. In the present embodiment, with regard to the plurality of pages of GUI drawings, the thumbnail images of the GUI drawings of the respective pages are arranged to be located at specific positions (specific in-page positions), such as an upper part or a central part.

In addition, as shown in FIG. 3, a code symbol 200 (for example, a two-dimensional code) is printed on the thumbnail list sheet 100. This code symbol includes information linking the position of the GUI drawing on a page to a part of the thumbnail list, that is, information providing a link to the layout information stored in the layout information storage 36.

The thumbnail outputting block 37 also allows the printer 3 to further print additional thumbnail list sheets, in each of which, the GUI drawing at each of the second to N-th pages is arranged at a central part of each sheet.

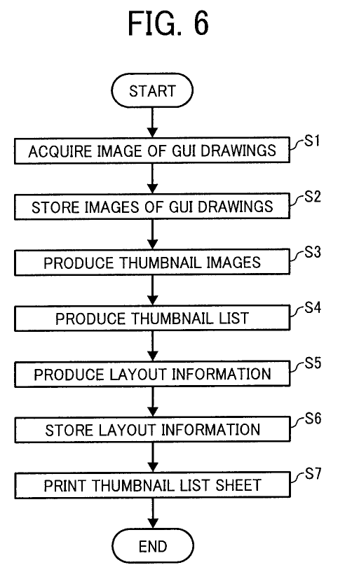

FIG. 6 is a flowchart showing a method of producing the thumbnail list sheet. As shown in FIG. 6, the image acquiring block 31 acquires the images of GUI drawings for a plurality of pages by initiating scanning the GUI drawings (step S1). The image storage 32 then stores therein the acquired drawing images (step S2).

As shown in FIG. 6, the thumbnail image producer 33 reduces the sizes of the acquired GUI drawing images of the plurality of pages to produce thumbnail images thereof (step S3). Then, the list producer 34 performs the production of a thumbnail list in which the thumbnail images of the plural pages are arranged each having represented thereon one or several sheets (step S4).

After this, as shown in FIG. 6, the layout information producer 35 produces N-variations of layout information correlating the GUI drawing position to the thumbnail list produced by the list producer 34 (step S5). In response to this, the layout information storage 36 stores therein the layout information produced by the layout information producer 35 (step S6), and the thumbnail outputting block 37 commands the printer 3 to print the thumbnail list sheet 100 (step S7).

[Link Setting Process]

A process for setting the link will now be described. As shown in FIG. 4, the computer 1 is provided with the CPU 12 which performs a link setting program, so that the computer 1 is functionally provided with an added-information extractor 41, an information recognizing block 42, and an information manager 43. The CPU 12 is operable on a given OS (operating system) of the computer 1.

The added-information extractor 41 reads in, via the scanner 4, the thumbnail list sheet 100 onto which is included the necessary addition of information (i.e., area information and link information, which will be described later). This extractor 41 then calculates a difference between the newly read-in information and the layout information currently stored in the layout information storage 36, which is determined using the code symbol 200 found on the thumbnail list sheet 100. Specifically this determined layout information indicates arrangement correspondence between the respective positional parts of the thumbnail list and the GUI drawings for each of the plural pages. Calculating the difference makes it possible to extract any new information (i.e., area information and link information) added to the thumbnail list sheet 100.

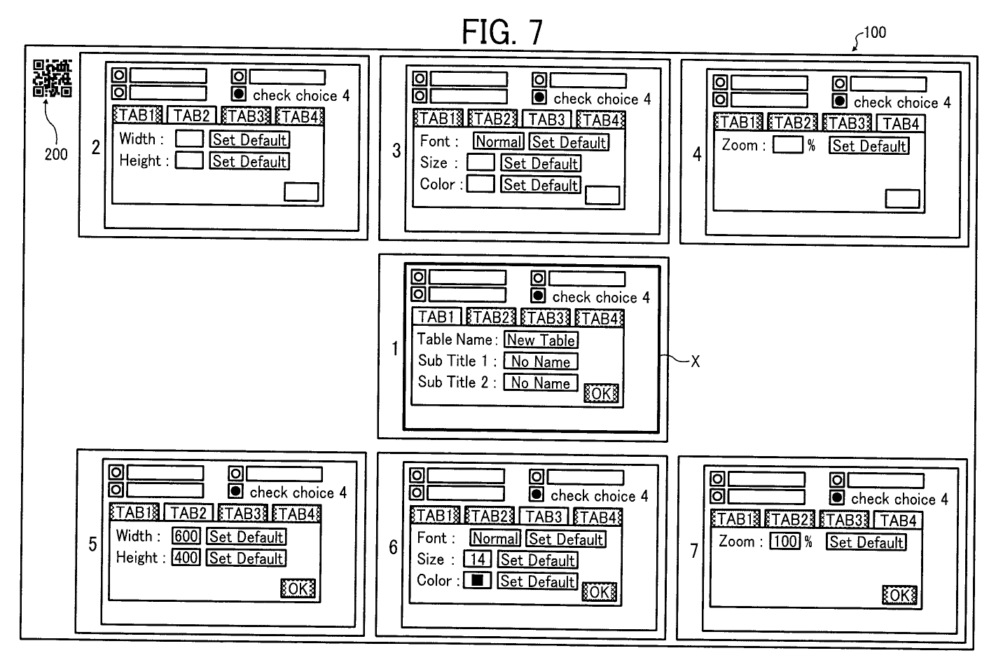

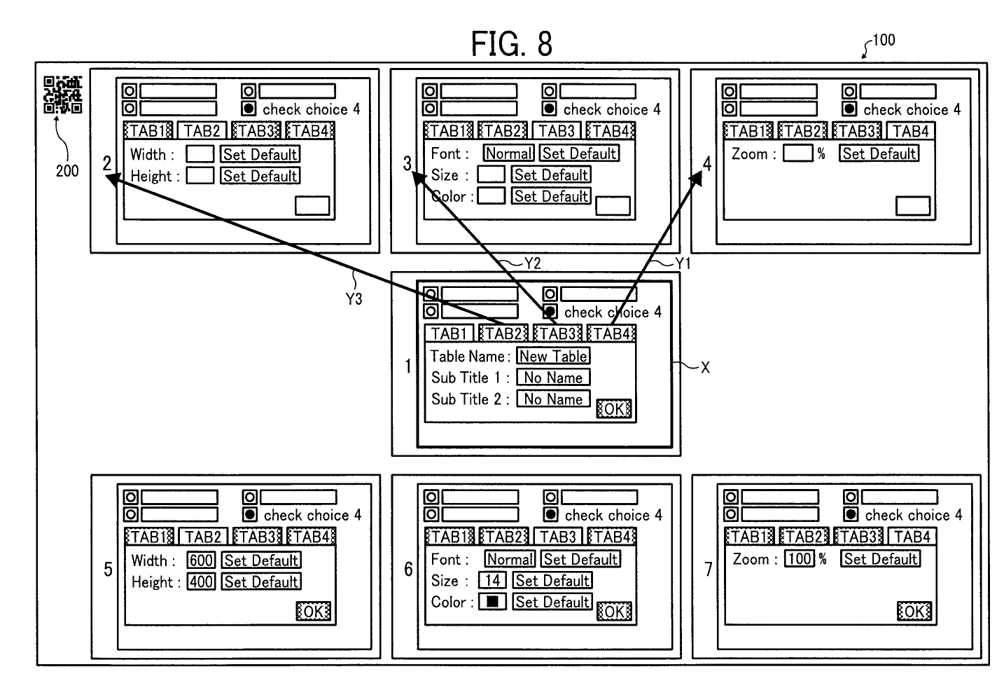

FIGS. 7 and 8 each exemplify the thumbnail list sheet 100 to which new information is added as described above, in which FIG. 7 shows an example of added area information and FIG. 8 shows an example of added area and link information. As shown in FIGS. 7 and 8, on the thumbnail image of a GUI drawing which is located at a central part of the sheet, area information X is added, while arrows showing pieces of link information Y1 to Y3 are added to extend from the area information X to the surrounding GUI-drawing thumbnail images of the other pages.

The information recognizing block 42 recognizes, from the information extracted by the added-information extractor 41, both area positions (i.e., area information) defined for the respective pages and the thumbnail images (i.e., link information) linked from the area positions. As shown in FIG. 7, on the assumption that the area information is depicted as a rectangular closed curve on the thumbnail list sheet 100, the coordinates of the four vertices of the closed curve are searched to designate those coordinates as the area information. Hence the information recognizing block 42 is able to accurately and reliably detect area positions added by hand.

In addition, on the assumption that, as shown in FIG. 8, the link information is depicted on the thumbnail list sheet 100 as directed segments (arrows) from specific areas on a thumbnail image to a thumbnail image of another page, the information recognizing block 42 recognizes the link information. That is, this device 42 makes correspondence between area information showing the start point of each directed segment and a thumbnail image at the end point of each directed segment, and sets the corresponded results as the link information. Hence, the information recognizing block 42 is able to accurately recognize thumbnail images linked from area positions added by hand.

The information manager 43, which is formed out of the HDD 15, RAM 14, or others, manages the area information and the link information, which are the area positions and the pages linked from the area positions, which are recognized by the information recognizing block 42.

As described, the area information and the link information are recognized on the basis of the assumption that the area information and the link information are depicted on the thumbnail images of the GUI drawings arranged at the specific in-page positions. As a result, similarly to a case where those pieces of information are defined on one sheet, it is possible to treat the area information and the link information which are defined on the plurality of thumbnail list sheets 100 in a partitioned manner.

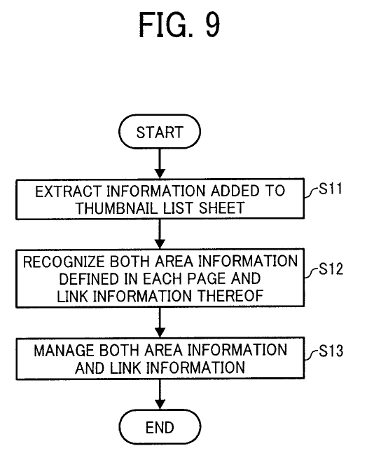

FIG. 9 is a flowchart illustrating a link setting process. As shown in FIG. 9, the added-information extractor 41 extracts information (i.e., area and link information) added to the thumbnail list sheet 100 (step S11). The information recognizing block 42 recognizes area positions (i.e., area information) defined in each page and thumbnail images (i.e., link information) linked from the area positions (step S12). The information manger 43 manages both the area positions and the thumbnail images which have been recognized (step S13).

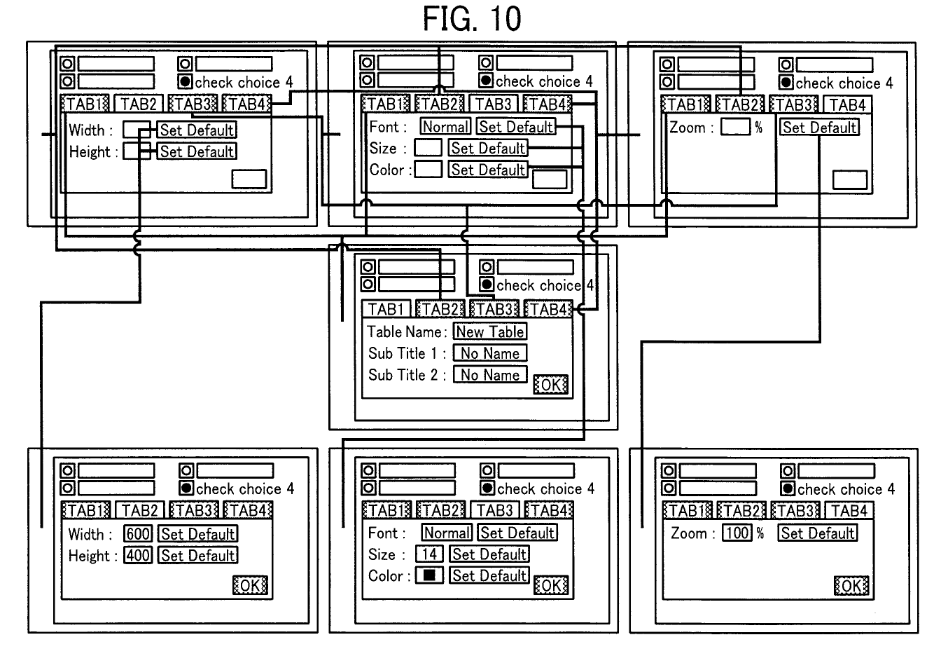

FIG. 10 shows an example of the link setting. Specifically, FIG. 10 presents all the area and link information for each GUI drawings on pages 1-4 together on one sheet.

[Drawing Display Process]

A process for displaying drawings will now be described. As shown in FIG. 4, the computer 1 allows the CPU 12 to perform a drawing display program operable on the operating system, according to which the computer 1 is functionally provided with a drawing display block 51, an instruction receiving block 52, a link acquiring block 53, and a display changing block 54.

The drawing display block 51 enables the display 19 to display the GUI drawing at the first page, which is stored in the image storage 32.

The instruction receiving block 52 responds to an operator's input action performed with the input device such as the keyboard 20, the mouse 21 or other input device. In response to such an action, the instruction receiving block 52 receives information showing a specific location on the GUI drawing which is now displayed by the display 19.

When the instruction receiving block 52 receives the information showing the specific location on the GUI drawing, the link acquiring block 53 determines whether or not the specific location is managed as the area information by the information manager 43. When the specific location is managed, the link acquiring block 53 acquires from the information manger 43 a linked destination which corresponds to the area information.

The display changing block 54 changes displayed contents of the display 19 to the GUI drawing according to a thumbnail image to be linked, which is acquired by the link acquiring block 53.

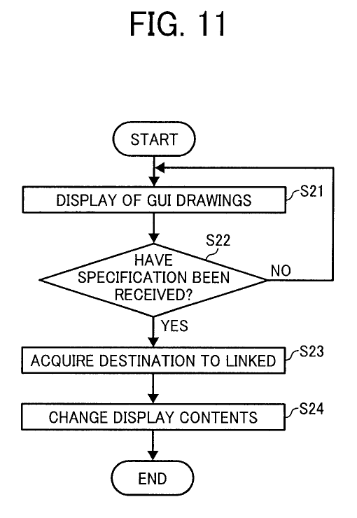

FIG. 11 is a flowchart illustrating the drawing display process. As shown in FIG. 11, the drawing display block 51 commands the display 19 to display the GUI drawing of the first page (step S21). Further the instruction receiving block 52 determines whether or not a specific location is specified on the GUI drawing now displayed by the display 19 by an operator's action via an input device (step S22). In cases where the instruction receiving block 52 receives information showing the selection of a specific location (YES at step S22), the link acquiring block 53 acquires from the information manager 43 a destination to be linked according to the area information, provided that the specified location is managed as a area information in the information manager 43 (step S23). The display changing block 54 then uses a thumbnail image of the linked destination in order to change the displayed contents on the display 19 to the GUI drawing corresponding to the updated thumbnail image (step S24).

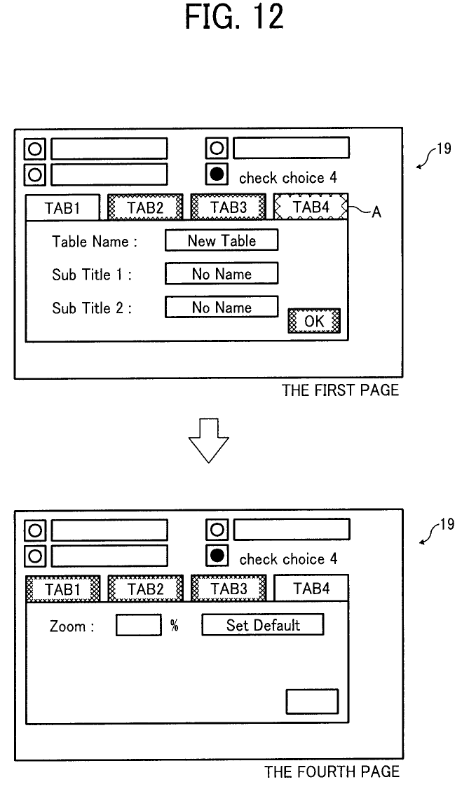

For example, in an example shown in FIG. 12, a shaded part A in the GUI drawing of the first page is specified (that is, the GIU drawing located at the central part pf the sheet 100 shown in FIG. 8). In this case, as shown in FIGS. 8 and 10, link information Y1 links area information X at the shaded part A as the destination to be linked, to the GUI drawing at the fourth page (that is, the GUI drawing located at an upper right part in the sheet 100 shown in FIG. 8). Thus, the display 19 is controlled to change its display contents from the first-page GUI drawing to the fourth-page GUI drawing.

In this way, it is possible to provide electronic contents in an interactive manner, in which the display screen is switched automatically in response to operator's selections on the apparatus.

According to the present embodiment, drawing images, which are images of a plurality of pages of drawings prepared for every scene, are acquired and stored in the image storage. In addition, respective drawing image are reduced in their sizes to produce thumbnail images, and a thumbnail list is produced in which the thumbnail images are arranged. When information is added to this thumbnail list, added information is extracted, and the extracted added information is used to recognize both area positions defined in the thumbnail list and thumbnail images linked from the area positions. The recognized results, i.e., the area positions and the thumbnail images are managed by the formation manager. In the state where the display represents the drawing images stored in the image storage, the apparatus receives information indicative of the fact that a specific location on the displayed drawing images is specified. In this case, provided that the specified location corresponds to one of the area positions managed in the information manager, a thumbnail image to be linked from the corresponding area position is acquired from the information manager. Based on the acquired thumbnail image, the displayed contents on the display are changed to the drawing image according to the linked thumbnail image. Hence, the plurality of pages of drawing images, prepared for every scene, can be hand-written images, for example. In this case, thanks to the use of hand writing, the drawing images can be prepared in an easy and quick manner. In addition, hyperlinks can be overlaid on these hand drawn images easily. Accordingly, it is possible to easily produce a prototype of contents which are displayed interactively.

Additionally, in the thumbnail list sheet 100, a plurality of pages of GUI drawings are arranged at the specific positions, such as a central part or an upper part of the sheet. This arrangement makes it easier to realize the links among the pages (that is, among the GUI drawings). Hence it is possible to improve both the visibility during work for adding link information and the accuracy of the area and link information recognized by the information recognizing block 42.

Incidentally, in the present embodiment, the thumbnail list sheet 100 shown in FIG. 3 is printed and a destination to be linked is added to this sheet 100. However, this is just one example, the system is not limited to using this sheet 100 in setting the area and link information. Alternatively, electronic means may be used to set the area and link information. Specifically, in the case where the thumbnail list sheet 100 is not used, the thumbnail outputting block 37 commands the display 19 to display the thumbnail list. The added-information extractor 41 accepts information inputted at the input device, and extracts information (i.e., area and link information) added to the thumbnail list displayed on the display 19. This recognition is carried out by calculating a difference from information currently stored in the layout information storage 36 (i.e., information indicative of the relationship between the GUI drawings at the respective pages and parts of the thumbnail list at which the GUI drawings are arranged) and the added information.

Hence, confirming the thumbnail list and setting the area and link information can be realized on the computer 1.

The present invention is not limited to the specifically disclosed embodiments, and variations and modifications may be made without departing from the scope of the present invention.

What is claimed is:

1. An information processing apparatus comprising:
a processor;
an image acquiring unit that acquires drawing images which are images corresponding to a plurality of prepared scenes on a plurality of pages of drawings;
an image storage that stores therein the respective drawing images;
a thumbnail image producer that produces thumbnail images by reducing a size of each of the drawing images;
a list producer that produces a thumbnail list in which the produced thumbnail images are arranged;
a thumbnail outputting unit that outputs the thumbnail list;
an entered-information extractor that extracts entered information entered into the thumbnail list;
an information recognizing unit that recognizes, from the added information, both area positions defined in the thumbnail list and the thumbnail images linked from the area positions; and
an information manager that controls storage of both the recognized area positions and the thumbnail images linked from the area positions.

2. The apparatus of claim 1, wherein, when the area positions are depicted on the thumbnail list as a rectangular closed curve, the information recognizing block recognizes, as the area positions, coordinates of four vertexes of the rectangular closed curve.

3. The apparatus of claim 1, wherein, when information showing the link is depicted on the thumbnail list as a directed segment from a specified area on the thumbnail images to the a thumbnail image at another page, the information recognizing block recognizes both the area position at a start point of the directed segment and the thumbnail image at an end point of the directed segment, the recognized area position and thumbnail image being made to correspond to each other.

4. The apparatus of claim 1, wherein the list producer arranges and produces the thumbnail list so that the thumbnail images are located at specified positions.

5. The apparatus of claim 1, wherein the thumbnail outputting block outputs the thumbnail list by making a printing section print the thumbnail list.

6. The apparatus of claim 1, wherein thumbnail outputting block outputs the thumbnail list by making a display section display the thumbnail list.

7. The apparatus of claim 1, wherein the information manager manages both the recognized area positions and the thumbnail images in a manner that recognized results of the thumbnail list are integrated.

8. The apparatus according to claim 1, further comprising:
a drawing displaying device that enables a display section to display the drawing images stored in the image storage;
an instruction receiving device that receives instructions showing a specified location on the drawing images displayed on the display section;
a link acquiring device that, when the instruction receiving device receives the instructions and the received specified location is managed as an area position, acquires a thumbnail image linked from the area position, from the information manager; and
a display changing device that changes displayed contents of the display section to the drawing images according to the linked thumbnail image acquired by the link acquiring device.

9. An information processing method comprising:
acquiring drawing images which are images corresponding to a plurality of prepared scenes on a plurality of pages of drawings;
storing in a image storage the respective drawing images;
producing thumbnail images by reducing a size of each of the drawing images;
producing a thumbnail list in which the produced thumbnail images are arranged;
outputting the thumbnail list;
extracting entered information entered into the thumbnail list;
recognizing, from the added information, both area positions defined in the thumbnail list and the thumbnail images linked from the area positions; and
controlling storage of both the recognized area positions and the thumbnail images linked from the area positions.

10. The apparatus of claim 9, wherein, when the area positions are depicted on the thumbnail list as a rectangular closed curve, the information recognizing step recognizes, as the area positions, coordinates of four vertexes of the rectangular closed curve.

11. The apparatus of claim 9, wherein, when information showing the link is depicted on the thumbnail list as a directed segment from a specified area on the thumbnail images to the a thumbnail image at another page, the information recognizing step recognizes both the area position at a start point of the directed segment and the thumbnail image at an end point of the directed segment, the recognized area position and thumbnail image being made to correspond to each other.

12. The apparatus of claim 9, wherein the producing a thumbnail list arranges and produces the thumbnail list so that the thumbnail images are located at specified positions.

13. The apparatus of claim 9, wherein the outputting the thumbnail list outputs the thumbnail list by making a printing section print the thumbnail list.

14. The apparatus of claim 9, wherein the outputting the thumbnail list outputs the thumbnail list by making a display section display the thumbnail list.

15. The apparatus of claim 9, wherein the controlling controls both the recognized area positions and the thumbnail images in a manner that recognized results of the thumbnail list are integrated.

16. The method according to claim 9, further comprising:
allowing a display section to display the drawing images stored in the image storage;
receiving instructions showing a specified location on the drawing images displayed on the display section;
when the instruction receiving device receives the instructions and the received specified location is managed as an area position, acquiring a thumbnail image linked from the area position, from an information manager; and
changing displayed contents of the display section to the drawing images according to the linked thumbnail image acquired by the acquiring.

17. A computer readable storage medium including computer program codes that when executed on a computer cause the computer to execute the image processing method comprising:
acquiring drawing images which are images corresponding to a plurality of prepared scenes on a plurality of pages of drawings;
storing in a image storage the respective drawing images;
producing thumbnail images by reducing a size of each of the drawing images;
producing a thumbnail list in which the produced thumbnail images are arranged;
outputting the thumbnail list;
extracting entered information entered into the thumbnail list;
recognizing, from the added information, both area positions defined in the thumbnail list and the thumbnail images linked from the area positions; and
controlling storage of both the recognized area positions and the thumbnail images linked from the area positions.
